(19) United States
(12) Patent Application Publication
(10) Pub. No.: US 2006/0192648 A1
(43) Pub. Date: Aug. 31, 2006

(54) Transformer and power supply apparatus

(76) Inventor: Tomokazu Suzuki, Maesawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/360,678

(22) Filed: Feb. 24, 2006

(30) Foreign Application Priority Data
Feb. 28, 2005 (JP) 2005-052254

(51) Int. Cl. H01F 27/30

(52) U.S. Cl. 336/208

(57) ABSTRACT

A transformer is comprised of an inner peripheral bobbin, an outer peripheral bobbin which is arranged in a coaxial manner with respect to the inner peripheral bobbin, an outer case which covers both the inner peripheral bobbin and the outer peripheral bobbin, and a position holding spacer which is interposed between the inner peripheral bobbin and the outer peripheral bobbin, in which the position holding spacer supports both the outer peripheral bobbin and the inner peripheral bobbin, so that the outer peripheral bobbin is not contacted with respect to both the inner peripheral bobbin and the outer case.

### INCORPORATION BY REFERENCE

The present application claims priority from Japanese application JP2005-052254 filed on Feb. 28, 2005, the content of which is hereby incorporated by reference into this application.

### BACKGROUND OF THE INVENTION

The present invention generally relates to a transformer and a power supply apparatus using the transformer. More specifically, the present invention is directed to, for instance, a construction of a high-voltage pulse transformer.

FIG. 5 illustratively shows an insulating construction of a high voltage transformer related to prior art. In this conventional high voltage transformer, normally, an inner peripheral-sided coil is employed as a primary input-sided winding, and an outer peripheral-sided coil is employed as a high voltage output winding, while the inner peripheral-sided coil is located closer to a core of the high voltage transformer, as compared with the outer peripheral-sided coil. A distance between these inner and outer peripheral-sided coils is secured in order not to exceed an insulation withstanding voltage which is set in correspondence with a filled insulating material. Also, in order to secure distances among the respective coils and bobbins and also to maintain the positions of these components, the following general-purpose method is employed. That is, the outer peripheral bobbin is supported by a brim of the inner peripheral bobbin so as to secure these distances and maintain these positions.

### SUMMARY OF THE INVENTION

Since the above-described high voltage transformer related to the prior art is employed, the below-mentioned problems are produced.

That is, since the brim of the inner peripheral bobbin is made in contact to an inner peripheral portion of the outer peripheral bobbin, there are some possibilities that discharge penetrates through the outer peripheral bobbin, and thereafter, evolves along a creeping surface of the brim of the inner peripheral bobbin. Since the discharge phenomenon occurred in the high voltage transformer may considerably deteriorate lifetime and reliability of the transformer, sufficiently long insulating distances must be secured in order to avoid these deteriorations. However, the transformer is necessarily made bulky due to the long insulating distances. Further, the transformer is made bulky, so that coupling conditions between the primary winding and the secondary winding are deteriorated. There is another problem that an energy transforming efficiency of the transformer is also deteriorated.

As a consequence, the present invention has an object to provide a high voltage transformer, the discharge resistance of which is higher than that of the conventional high voltage transformer.

The above-described object of the present invention may be achieved based upon a scope of claims for a patent according to the present invention.

In accordance with the present invention, a compact high-voltage transformer can be provided, and the discharge resistance thereof is higher than that of the conventional high voltage transformer.

### BRIEF DESCRIPTION OF THE DRAWINGS

These and other features, objects and advantages of the present invention will become more apparent from the following description when taken in conjunction with the accompanying drawings wherein:

FIG. 1 is an insulating structural diagram of a high voltage transformer according to a first embodiment of the present invention;

FIG. 2 is an assembling diagram of a bobbin according to the first embodiment;

FIG. 3 is another insulating structural diagram of the high voltage transformer according to the first embodiment of the present invention;

FIG. 4 is an insulating structural diagram of a high voltage transformer according to a second embodiment of the present invention, and a diagram for indicating a detailed fitting mechanism of an outer peripheral bobbin thereof;

FIG. 5 is the structural diagram for showing the conventional high voltage transformer;

FIG. 6 is an outer view of an inner peripheral bobbin of a high voltage transformer according to a third embodiment of the present invention, and an assembling diagram of the inner peripheral bobbin thereof;

FIG. 7 is another outer view of the inner peripheral bobbin of the high voltage transformer according to the third embodiment of the present invention, and an assembling diagram of the inner peripheral bobbin thereof;

FIG. 8 represents an example of a Full Bridge type transformer drive circuit according to a fourth embodiment of the present invention;

FIG. 9 represents an example of a Half Bridge type transformer drive circuit according to the fourth embodiment of the present invention;

FIG. 10 represents an example of a Fly-Back type transformer drive circuit according to the fourth embodiment of the present invention; and

FIG. 11 is an assembling diagram of a bobbin of the high voltage transformer according to the second embodiment of the present invention.

### DESCRIPTION OF THE EMBODIMENTS

A description is made of 5 embodiment modes for carrying out the present invention.

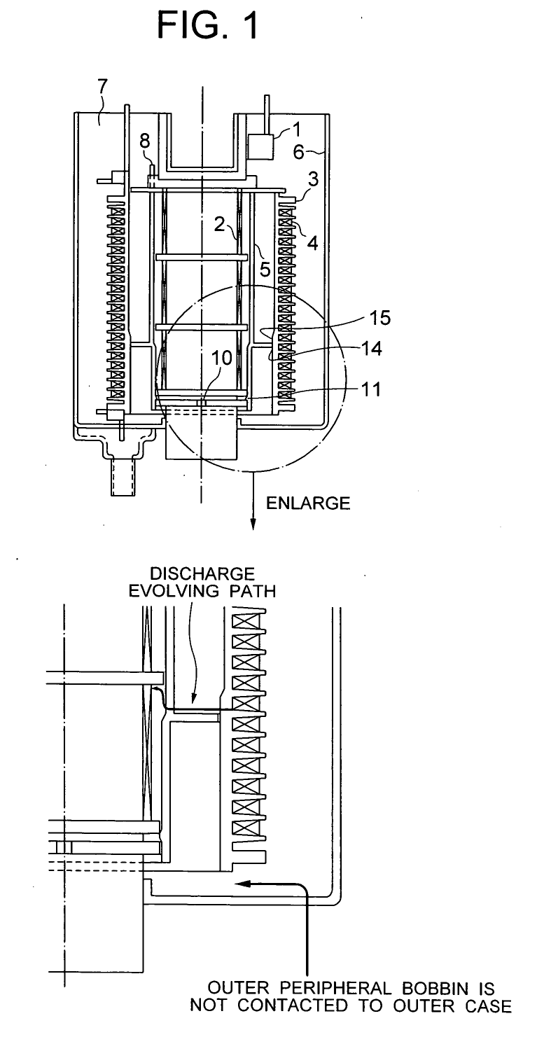

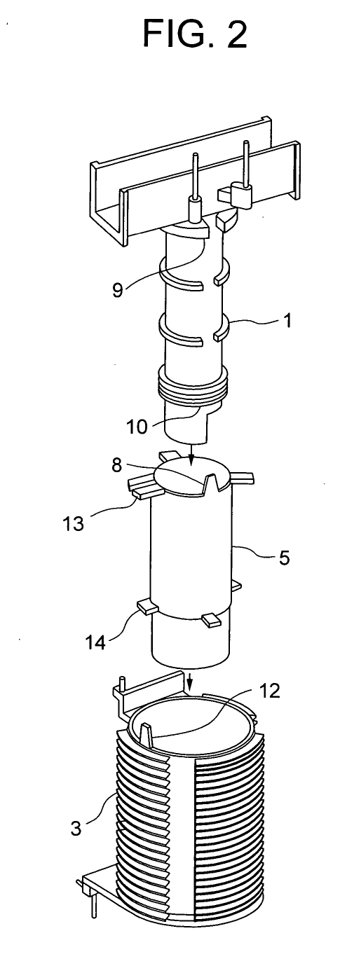

FIG. 1 is a diagram for illustratively indicating an insulating structure of a high voltage transformer according to a first embodiment of the present invention. FIG. 2 is an assembling diagram of a bobbin employed in the transformer according to the first embodiment of the present invention.

It should be noted that in FIG. 1, an upper side corresponds a low voltage side of a high voltage winding and will be referred to as a “low voltage side” hereinafter, whereas a lower side corresponds to a high voltage side of the high voltage winding and will be referred to as a “high voltage side” hereinafter.

A primary input winding 2 is wound on an inner peripheral bobbin 1, a high voltage output winding 4 is wound on an outer peripheral bobbin 3, and as indicated in FIG. 2, a position holding-purpose spacer 5 is inserted between the inner peripheral bobbin 1 and the outer peripheral bobbin 3, so that a bobbin group is formed in which the respective structural components are fixed. Then, this bobbin group is fitted to an outer case 6 by the inner peripheral bobbin 1, and an insulating material 7 is filled inside the outer case 6.

A diameter of a winding portion of the inner peripheral bobbin 1 is determined based upon a core diameter to be used, whereas a diameter of a winding portion of the outer peripheral bobbin 3 is determined based upon a pass-through insulation withstanding voltage distance. The pass-through insulation withstanding voltage distance is determined based upon both an outer diameter of the winding portion of the inner peripheral bobbin 1, a used voltage, and a filled insulating material.

One piece, or more pieces of positioning ribs 8 are provided on the low voltage side of the spacer 5. A positioning notch 9 which corresponds to the above-described rib 8 is formed in the brim of the inner peripheral bobbin 1 on the lowermost voltage side. Since the rib 8 is inserted into this positioning notch 9, a positioning operation between the inner peripheral bobbin 1 and the spacer 5 along a circumferential direction is performed.

One piece, or more pieces of spacers 5 and fitting-purpose ribs 10 are provided on a brim of the high voltage side of the inner peripheral bobbin 1. Another rib 11 which corresponds to the above-described fitting-purpose rib 10 is provided on an inner peripheral portion of the spacer 5. These ribs 10 and 11 fit and fix the inner peripheral bobbin 1 to the spacer 5, and further, perform a positioning operation between the inner peripheral bobbin 1 and the spacer 5 along a bobbin insertion direction.

Similarly, one piece, or more pieces of positioning ribs 12 are formed on the outer peripheral bobbins 3, and a positioning notch 13 which corresponds to the positioning ribs 12 is formed on the spacer 5 so as to perform a positioning operation between the spacer 5 and the outer peripheral bobbin 3.

As shown in a discharge evolving path of an enlarged view of FIG. 1, the brim of the high voltage side of the spacer 5 is provided at a position in such a manner that after discharge penetrates through the outer peripheral bobbin 3, the discharge evolves a creeping surface of this brim and then is not reached to the primary winding 2. Also, a fitting/fixing-purpose rib 14 is provided on this brim of the spacer 5, and this fitting/fixing-purpose rib 14 is fitted to another rib 15 of the outer peripheral bobbin 3, which corresponds to the rib 14, so that the outer peripheral bobbin 3 is fixed with respect to the spacer 5.

As explained above, the outer peripheral bobbin 3 is fixed via the spacer 5 with respect to the inner peripheral bobbin 1. As a result, the outer peripheral bobbin 3 is not contacted with respect to the inner peripheral bobbin 1.

Also, as represented in the enlarged view, the outer peripheral bobbin 3 is designed in such a way that the outer peripheral bobbin 3 is not contacted to the outer case 6 when the bobbin group is fitted into the outer case 6.

Since the high voltage transformer is constructed in the above-explained manner, the high voltage winding bobbin is not contacted with respect to both the outer case 6 and the primary input winding bobbin, and the distance of the creeping surface discharge is prolonged which is evolved from the high voltage side of the high voltage winding along the surfaces of the components, so that the diameter of the outer peripheral bobbin 3 can be suppressed to such a diameter which is determined by a pass-through withstanding voltage between the primary winding 2 and the high voltage winding 4. Since such a construction of the transformer is made, the creeping surface withstanding voltage of this transformer according to the first embodiment can be increased as compared with that of the conventional transformer, which may contribute to make this transformer compact.

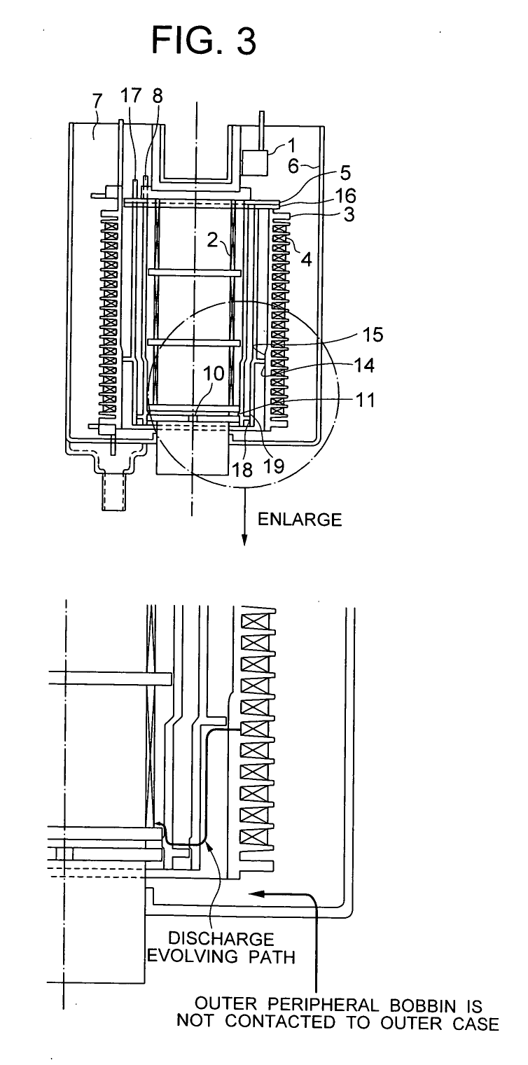

Further, the longer a distance between a positioning rib on the low voltage side and a fitting-purpose rib on the high voltage side becomes, the smaller an inclination of a bobbin becomes. As a result, in the case that a high-voltage-sided brim of a spacer is excessively approached to a low-voltage-sided brim of the spacer and therefore the inclination of the bobbin cannot be neglected, and/or in such a case that a height of the brim of the spacer is extremely increased and therefore a strength of this brim has a problem, as illustrated in FIG. 3, plural sets of spacers are employed, and positions of the high-voltage-sided brims of these spacers are positionally shifted. As a result, a creeping distance of this transformer shown in FIG. 3 may be made longer than the creeping distance of the above-explained transformer shown in FIG. 1. As a result, since such a construction of the transformer shown in FIG. 3 is made, a creeping surface withstanding voltage thereof may be increased, as compared with that of the conventional transformer, which may contribute to make this transformer of FIG. 3 compact.

In addition to the positioning purpose, a large number of notches have been formed in the inner peripheral bobbin 1, the outer peripheral bobbin 3, and the brim of the spacer 5 over a wide range as large as possible in order that penetrating characteristics of insulating filled materials and removing characteristics of bubbles may be improved.

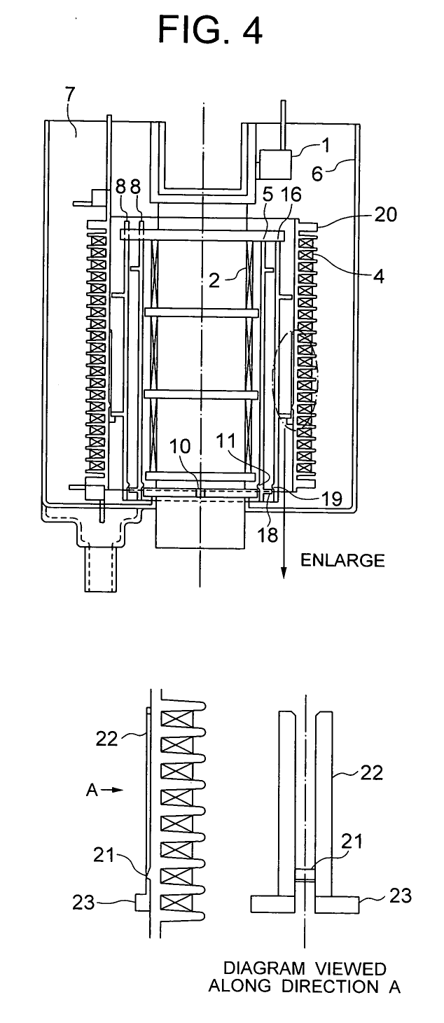

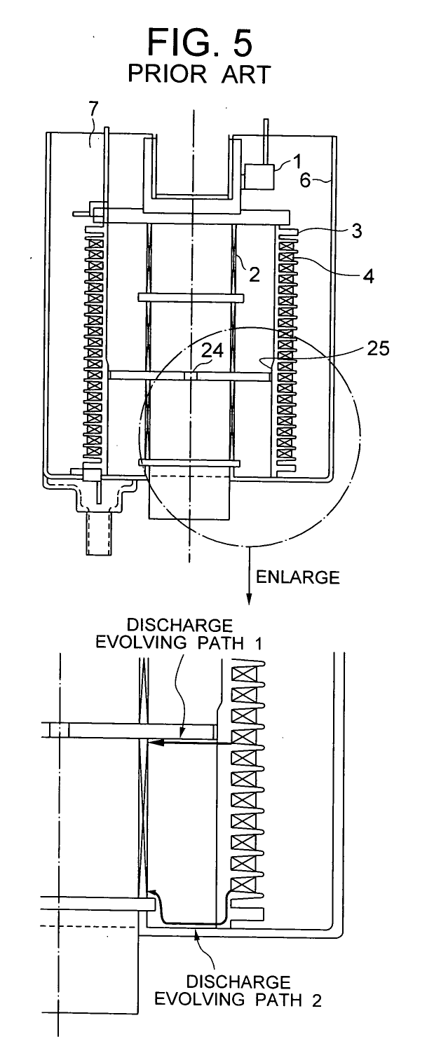

FIG. 4 is an insulating structural diagram of a high voltage transformer according to a second embodiment of the present invention, and an enlarged view for indicating a fitting mechanism of an outer peripheral bobbin 20 thereof. This high voltage transformer is featured by eliminating the positioning-purpose rib 12 of the low voltage side of the outer peripheral bobbin 3, the positioning-purpose notches 9 and 13 of the spacers 5 and 16, and the brims of the low voltage side of the spacers 5 and 16 from the structure of the transformer shown in FIG. 1.

Guide rails 22 are provided on an inner peripheral portion of this outer peripheral bobbin 20 respectively so as to position the spacer 16 with respect to the outer peripheral bobbin 20 along a circumferential direction. These guide rails 22 are employed in order to conduct a plurality of fitting-purpose ribs 18 formed on the spacer 16 to fitting-purpose ribs 21 of the outer peripheral bobbin 20.

While the fitting-purpose ribs 21 and positioning-purpose screens 23 are formed on terminals of the guide rails 22, since the brim of the spacer 16, on which the fitting-purpose ribs 18 are formed, abuts against the screens 23, it is possible to avoid that the outer peripheral bobbin 20 is furthermore inserted so as to position the outer peripheral bobbin 20 with respect to the bobbin insertion direction.

Accordingly, the contact between the outer peripheral bobbin 20 and the spacer 16 is limited only to the inner peripheral side of the outer peripheral bobbin 20. As a consequence, creeping distances from the outer peripheral bobbin 20 to the inner peripheral bobbin 1 can be increased irrespective of the low voltage side and the high voltage side, which may contribute to make a shape of a transformer compact even in such a transformer which requires insulation between a primary winding and a secondary winding. Also, since the shape of the transformer can be reduced, a coupling condition between a high voltage winding and a low voltage winding may be improved. As a result, an energy transforming efficiency of this transformer may also be improved.

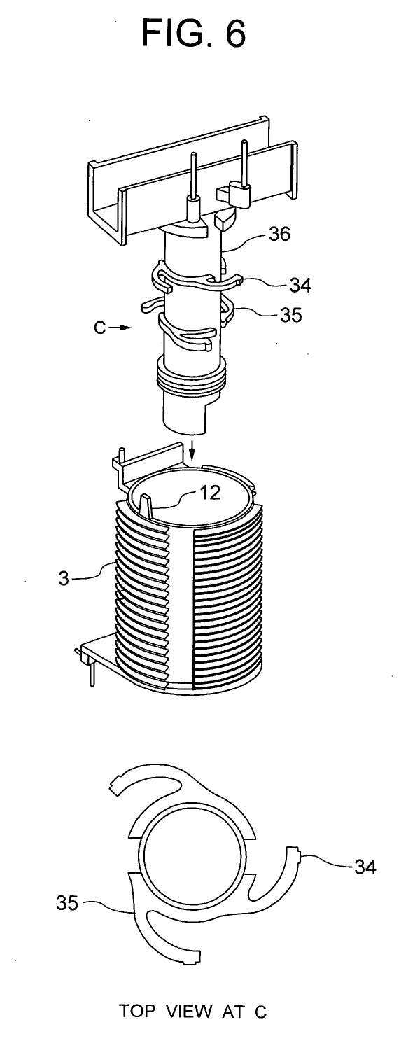

FIG. 6 an outer view for representing an inner peripheral bobbin, and an assembling diagram for indicating an assembly between the inner peripheral bobbin and an outer peripheral bobbin, according to a third embodiment of the present invention. It should be understood that the same reference numerals shown in FIG. 1 will be employed as those for indicating the same, or similar structural elements of FIG. 6.

In FIG. 6, while a primary input winding 2 is wound on this inner peripheral bobbin 36, the inner peripheral bobbin 36 wound with the primary input winding 2 is inserted and fitted into an outer peripheral bobbin 3 on which a high voltage output winding 4 has been wound so as to form a bobbin group. Then, the bobbin group is fitted to an outer case 6 via the inner peripheral bobbin 36, and an insulating material 7 is filled inside the outer case 6.

A fitting-purpose holding arm 35 is provided on the inner peripheral bobbin 36, and is extended toward a bobbin outer peripheral direction. A fitting-purpose rib 34 is provided on the outermost peripheral portion of the inner peripheral bobbin 36, while the fitting-purpose rib 34 is fitted to the outer peripheral bobbin 3. This fitting-purpose rib 34 is fitted to a fitting-purpose rib 15 so as to be fixed. The fitting-purpose rib 15 is provided on the inner peripheral portion of the outer peripheral bobbin 3 in correspondence with this fitting-purpose rib 34.

In the transformer of this third embodiment, discharge penetrates from the high voltage output winding 4 through the outer peripheral bobbin 3, and thereafter, passes in the vicinity of the fitting-purpose rib 4, and then, evolves a creeping surface of the rib holding arm 35 to be reached to the primary input winding 2. Since the rib holding arm 35 is curved, a creeping surface discharge distance can be made long. As a result, a creeping surface discharge withstanding voltage can be increased, which may contribute to make the transformer compact.

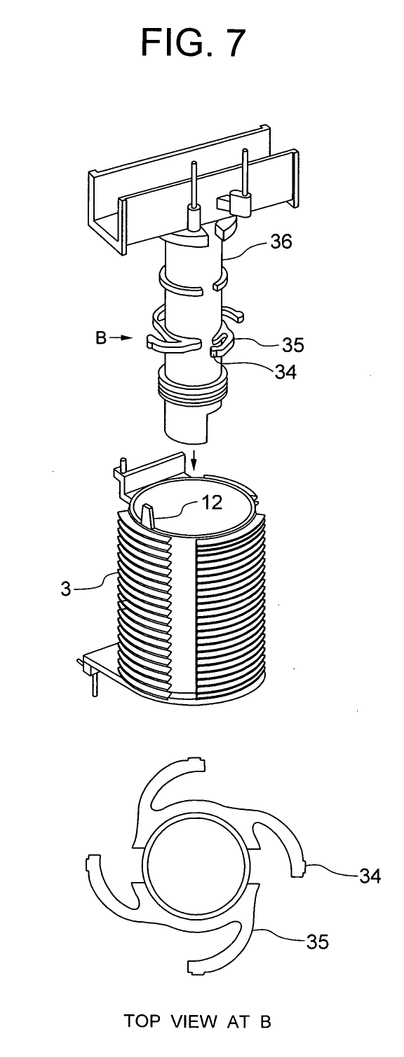

FIG. 7 as outer view for representing an inner peripheral bobbin, and an assembling diagram for indicating an assembly between the inner peripheral bobbin and an outer peripheral bobbin, according to a modification of the third embodiment of the present invention.

In this modification, a plurality of rib holding arms 35 having fitting-purpose ribs 34 are provided on a plurality of brims, so that inclinations caused by flexures of the rib holding arms 35 when the bobbin is fitted thereto can be suppressed to a small value. The fitting-purpose ribs 34 provided on the respective brims are arranged in such a manner that positions thereof on a circumference with respect to a central axis of the bobbin are different from each other.

Next, a description is made of a power supply apparatus with employment of the transformer related to any one of the first to third embodiments of the present invention.

The power supply apparatus is equipped with: the transformer related to any one of the first to third embodiments of the present invention; a power source apparatus for applying a voltage so as to drive the low voltage winding of the transformer; an arbitrary number of switching elements which switch the drive voltage; and a circuit which controls turning-ON/OFF operations of these switching elements.

General-purpose transformer drive circuits for the power supply apparatus are explained as follows:

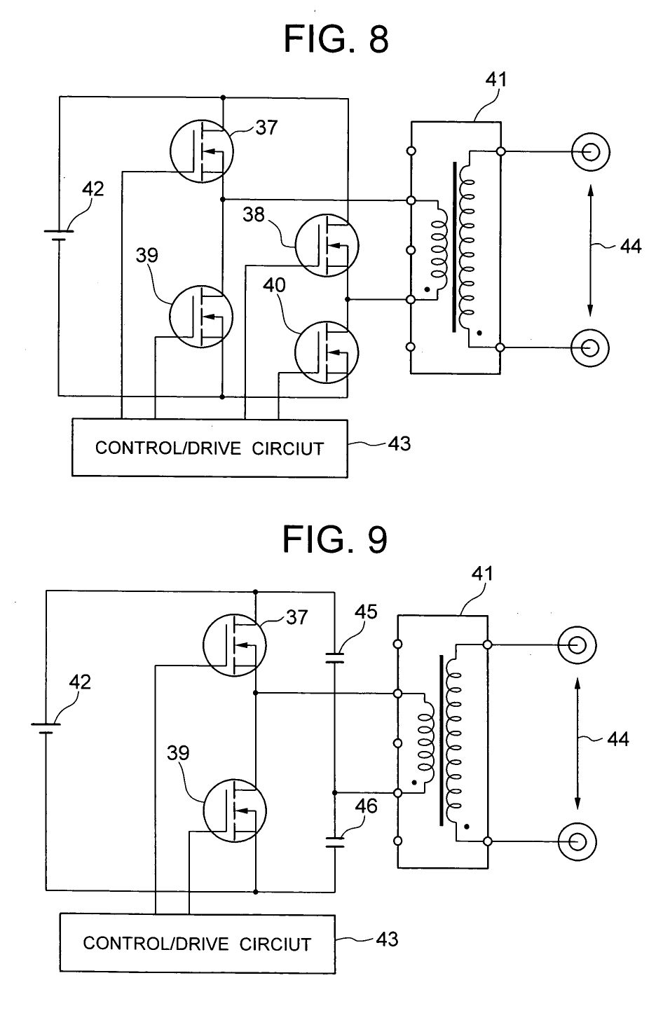

FIG. 8 indicates an inverter circuit having a general-purpose Full-Bridge construction as the drive circuit of the transformer.

FIG. 9 indicates an inverter circuit having a general-purpose Half-Bridge construction as the drive circuit of the transformer.

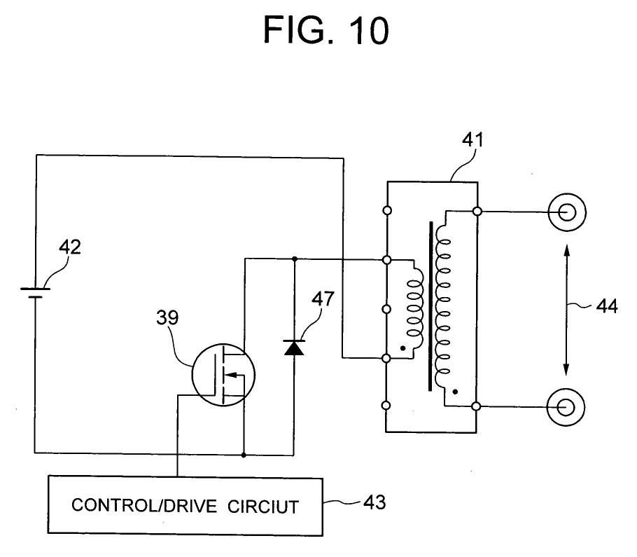

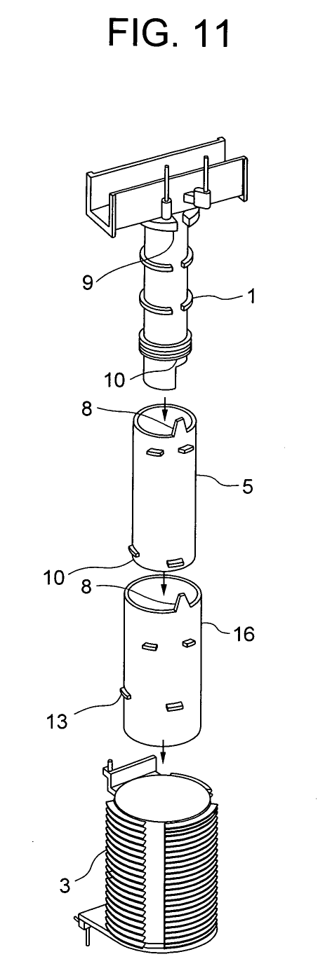

FIG. 10 indicates an inverter circuit having a general-purpose Fly-Back construction as the drive circuit of the transformer.

Since the transformer related to any one of the first to third embodiments of the present invention is applied to the power supply apparatus, both an output voltage and an output current which are substantially equal to those of the conventional power supply apparatus can be obtained by using a more compact transformer, and furthermore, the energy transforming operation thereof can be carried out in a higher efficiency. As a result, the transformer and the power supply apparatus except for the transformer can be made in smaller sizes.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

1. A transformer comprising:
an inner peripheral bobbin;
an outer peripheral bobbin which is arranged in a coaxial manner with respect to said inner peripheral bobbin;
an outer case which covers both said inner peripheral bobbin and said outer peripheral bobbin; and
a position holding spacer which is interposed between said inner peripheral bobbin and said outer peripheral bobbin; wherein:
said position holding spacer supports both said outer peripheral bobbin and said inner peripheral bobbin, so that said outer peripheral bobbin is not contacted with respect to both said inner peripheral bobbin and said outer case.

2. A transformer comprising:
a high voltage winding bobbin on which a high voltage winding is wound;
a low voltage winding bobbin on which a low voltage winding is wound, said low voltage winding bobbin being arranged in a coaxial manner with respect to said high voltage winding bobbin;
an outer case which covers both said high voltage winding bobbin and said low voltage winding bobbin; and
a position holding spacer which is interposed between said high voltage winding bobbin and said low voltage winding bobbin; wherein:
said position holding spacer supports both said high voltage winding bobbin and said low voltage winding bobbin, so that said high voltage winding bobbin is not contacted with respect to said low voltage winding bobbin and said outer case.

3. A transformer comprising:
a high voltage winding bobbin on which a high voltage winding is wound;
a low voltage winding bobbin on which a low voltage winding is wound, said low voltage winding bobbin being arranged in a coaxial manner with respect to said high voltage winding bobbin;
an outer case which covers both said high voltage winding bobbin and said low voltage winding bobbin; and
a position holding spacer which is interposed between said high voltage winding bobbin and said low voltage winding bobbin; wherein:
said position holding spacer is contacted only with an inner peripheral portion of said high voltage winding bobbin.

4. A transformer comprising:
an outer peripheral bobbin on which a high voltage winding is wound; and
an inner peripheral bobbin having a fitting rib which is fitted to said outer peripheral bobbin, and a rib holding arm which holds said fitting rib, on which a low voltage winding is wound and which is arranged in a coaxial manner with respect to said outer peripheral bobbin; wherein:
said holding arm is curved, so that a creeping surface distance between said low voltage winding and an inner surface of said outer peripheral bobbin is expanded.

5. A transformer as claimed in claim 1 wherein:
a creeping surface discharge withstanding voltage between said low voltage winding bobbin and said high voltage winding bobbin is improved.

6. A power supply apparatus comprising:
a transformer comprising an inner peripheral bobbin, an outer peripheral bobbin which is arranged in a coaxial manner with respect to said inner peripheral bobbin, an outer case which covers both said inner peripheral bobbin and said outer peripheral bobbin, and a position holding spacer which is interposed between said inner peripheral bobbin and said outer peripheral bobbin, wherein said position holding spacer supports both said outer peripheral bobbin and said inner peripheral bobbin, so that said outer peripheral bobbin is not contacted with respect to both said inner peripheral bobbin and said outer case;
a power source unit for applying a voltage which is used to drive the low voltage winding of said transformer;
an arbitrary number of switching elements which switch the voltage applied from said power source unit; and
a circuit which controls turning ON/OFF operations of said switching elements.
